(19) United States
(12) Patent Application Publication
(10) Pub. No.: US 2024/0387938 A1
(43) Pub. Date: Nov. 21, 2024

(54) Battery for an electric vehicle

(71) Applicant: Dr. Ing. h.c. F. Porsche Aktiengesellschaft, Stuttgart (DE)

(72) Inventors: Christopher Volkmer, Niefern-Öschelbronn (DE); Sascha Mostofi, Stuttgart (DE); Daniel Fink, Ludwigsburg (DE)

(73) Assignee: Dr. Ing. h.c.F. Porsche Aktiengesellschaft, Stuttgart (DE)

(21) Appl. No.: 18/663,271

(22) Filed: May 14, 2024

(30) Foreign Application Priority Data
May 17, 2023 (DE) 10 2023 112 978.3

(51) Int. Cl. H01M 50/383; H01M 50/204; H01M 50/242; H01M 50/293; H01M 50/30; H01M 50/342

(52) U.S. Cl. CPC H01M 50/383; H01M 50/204; H01M 50/242; H01M 50/293; H01M 50/3425; H01M 50/394; H01M 2220/20

(57) ABSTRACT

A battery of an electric vehicle, having a battery housing, which delimits a housing interior, and a battery cell packet, which is arranged in the housing interior and has at least two battery cells arranged next to each other. The battery cells are electrically connected to each other via cell connection elements arranged on a first end face of the battery cell packet. An intermediate element is arranged between the two battery cells and is configured such that the battery cells support each other via the intermediate element in the stacking direction of the battery cell packet. The intermediate element projects beyond the second end face of the battery cell packet on a second end face of the battery cell packet opposite the cell connection elements.

### CROSS-REFERENCE TO RELATED APPLICATION

This application claims priority to German Patent Application No. 10 2023 112 978.3, filed May 17, 2023, the content of such application being incorporated by reference herein in its entirety.

### FIELD OF THE INVENTION

The invention relates to a battery of an electric vehicle, having a battery housing, which delimits a housing interior, and a battery cell packet, which is arranged in the housing interior and at least two battery cells arranged next to each other, wherein the battery cells are electrically connected to one another via cell connection elements arranged on a first end face of the battery cell packet, and wherein an intermediate element is arranged between the two battery cells, which is configured such that the battery cells support each other via the intermediate element in the stacking direction of the battery cell packet.

### BACKGROUND OF THE INVENTION

In the event of a thermal runaway of one of the battery cells, hot gases escape from the corresponding battery cell, wherein the hot gases typically escape from the corresponding battery cell at an end face of the battery cell packet in a battery cell stack. The problem with hot gases escaping from the battery cell in this way is that there is a risk of the hot gas infecting the other intact battery cells. Typically, the battery housing comprises a degassing device through which the hot gas is discharged from the housing interior.

### SUMMARY OF THE INVENTION

Described herein is a battery in which the risk of infection of an intact battery cell by the hot gases that flow into the housing interior during a thermal runway of a defective battery cell is reduced.

According to aspects of the invention, the intermediate element projects beyond the second end face of the battery cell packet at a second end face of the battery cell packet opposite the cell connection elements such that the intermediate element divides a cavity adjacent to the second end face of the battery cell packet into a first chamber associated with the one battery cell and a second chamber associated with the other battery cell.

In the event of a thermal runway of a battery cell, hot gases flow from the battery cell, in particular from the battery cell housing of the battery cell, into a cavity present in the housing cavity. In the present case, the hot gases flow from the defective battery cell into the cavity present on the second end face of the battery cell packet and are discharged from the cavity by a degassing device. In this case, the portion of the intermediate element projecting beyond the second end face of the battery cell packet prevents the hot gases from flowing to the other intact battery cell in a simple and cost-efficient manner, thereby preventing the intact battery cell from being infected by the hot gases or at least reducing the risk of infection on the intact battery cell. For this purpose, only the intermediate element, which already serves to support the battery cells against each other, is extended so that the cavity, i.e., the degassing chamber, is divided into two separate chambers. The extension of the intermediate element is specifically provided on the second end face of the battery cell packet, as this means that the electrical coupling of the battery cells provided on the first end face of the battery cell packet by means of the cell connection elements does not have to be considered and the cavity can therefore be easily separated into two chambers. The end of the intermediate element that projects beyond the second end face of the battery cell packet adjoins a housing wall and is preferably connected to it in a fluid-tight manner.

Preferably the battery cell packet has at least three battery cells, which are preferably connected in series, wherein a pair of two battery cells adjacent to each other are connected to each other on the first end face of the battery cell packet via cell connection elements and a second pair of two battery cells adjacent to each other are electrically connected on the second end face via cell connection elements, wherein a first intermediate element arranged between the two battery cells of the first pair projects beyond the second end face of the battery cell packet and a second intermediate packet arranged between the two battery cells of the second pair projects beyond the first end face of the battery cell packet, such that a first cavity adjacent to the second end face of the battery cell packet is divided by the first intermediate element into two chambers and a second cavity adjacent to the first end face of the battery cell packet is divided by the second intermediate element into two chambers. Cavities are provided on both end faces of the battery cell packet, in which the hot gases can escape during a thermal runaway of a battery cell, wherein both cavities are each divided into multiple chambers by an intermediate element with a section projecting beyond the corresponding end face, thereby reducing the risk of infection of other battery cells.

Preferably, the battery housing has one degassing opening per chamber. As a result, the hot gases escaping from a defective battery cell can be discharged directly from the battery housing. Preferably, a degassing device is arranged at the degassing opening, which is configured so that the chamber is sealed off from the outside environment in the normal state and a fluidic connection is established between the outside environment and the chamber in the event of a thermal runway of the battery cell and, for example, a pressure increase in the chamber.

In a preferred configuration, the intermediate element is made of a compressible material, preferably a foam material. The foam material is in particular a PU foam or a silicone foam. During operation of the battery cells, i.e., during charging and discharging, the volume and propagation of the battery cells in the stacking direction changes with a so-called swelling. The intermediate elements can absorb the change in volume and prevent high mechanical strains on the battery cells.

Preferably the intermediate element is arranged in multiple layers and comprises a fire protection layer on at least one of the two sides facing the battery cells. Preferably, the fire protection layer is made of mica. Mica composites are non-combustible, have very low thermal conductivity and exceptionally high thermal stability, even at temperatures above 1000° C., and are therefore very well suited for the fire protection layer.

As a result, reliable separation of the chambers can be achieved, wherein combustion of the intermediate element by the fire protection layer can be reliably prevented. Alternatively, only the portion of the intermediate element which projects beyond the end face of the battery cell packet can have the fire protection layer.

In a preferred embodiment, the multi-layered intermediate element comprises two fire protection layers and an intermediate layer arranged between the two fire protection layers made of a compressible material. As a result, the volume changes present due to the swelling can be balanced by the intermediate element, and burning of the intermediate element can be avoided.

Preferably the battery housing has a base body configured as an extruded profile and two covers closing the open end faces of the base body. As a result, the battery housing may be manufactured in a simple and cost-efficient manner.

In a preferred configuration, the battery cells have a degassing device at least on the end face of the battery cell packet, at which the intermediate element projects beyond the end face of the battery cell packet. The degassing device may be a predetermined breaking point provided on the battery cell case, a degassing opening having a burst membrane, or a degassing valve. As a result, the hot gas, which is present inside the battery cell housing during the thermal runway and causes a pressure increase in the battery cell housing, can be discharged from the battery cell housing at a predefined point.

### BRIEF DESCRIPTION OF THE DRAWINGS

An embodiment example of the invention is explained in further detail with reference to the drawings.

FIG. 1 schematically shows a battery in cross-section, and

FIG. 2 schematically shows a section of the battery of FIG. 1.

### DETAILED DESCRIPTION OF THE INVENTION

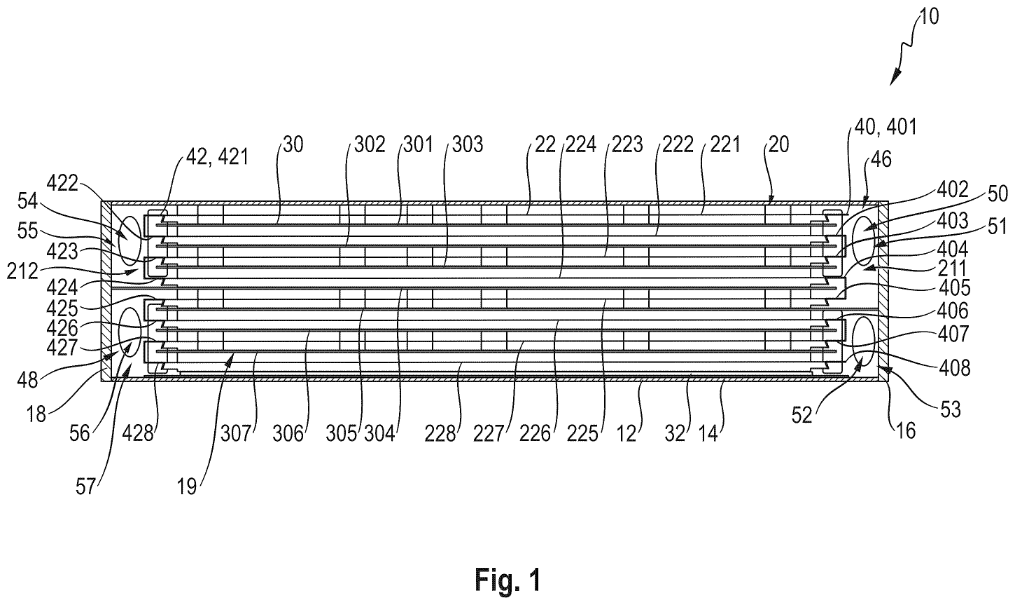

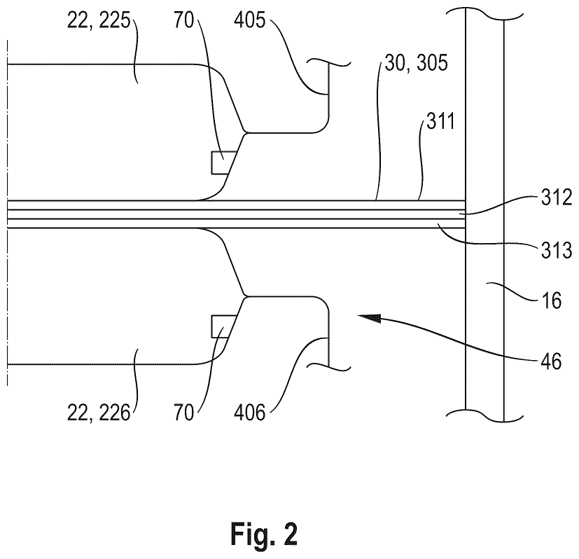

FIG. 1 shows a battery 10 for an electric vehicle, which serves to supply electrical energy to an electric drive unit. The battery 10 may also be a battery module of an overall battery composed of a plurality of battery modules. FIG. 2 schematically shows a section of the battery 10.

The battery 10 comprises a battery housing 12, which comprises a base body 14 and two covers 14, 16. The base body 14 is designed as an extrusion profile and has a rectangular, annular cross-section. The end faces of the base body 14 are generally open and, in the final assembled state, are each sealed in a fluid-tight manner by a cover 16, 18. The battery housing 12 delimits a housing interior 19 in which a battery cell packet 20 is arranged.

As an example, the battery cell packet 20 comprises eight battery cells 22, which are arranged next to each other in stacks in the housing interior 19. An intermediate element 30 is arranged between two battery cells 20 adjacent to each other, which is made of a compressible material, in particular a foam material, to compensate for so-called swelling during operation of the battery 10. Thus, a first intermediate element 301 is arranged between a first and a second battery cell 221, 222, a second intermediate element 302 is arranged between the second and a third battery cell 222, 223, a third intermediate element 303 is arranged between the third and fourth battery cell 223, 224, a fourth intermediate element 304 is arranged between the fourth and a fifth battery cell 224, 225, a fifth intermediate element 305 is arranged between the fifth and sixth battery cell 225, 226, a sixth intermediate element 306 is arranged between the sixth and a seventh battery cell 226, 227 and a seventh intermediate element 307 is arranged between the seventh and eighth battery cells 227, 228. The first battery cell 221 directly abuts a side facing away from the second battery cell 222 on an inner housing surface of the base body 14 in a sealing manner and the eighth battery cell 228 is supported on the inner housing surface of the base body 14 via a compensation element 32. The compensation element 32 seals the gap between the eighth battery cell 228 and the housing inner surface of the base body 14. The battery cell packet 20 delimits a first cavity 46 with a first end face 211 together with the cover 16. In addition, the battery cell packet 20 delimits a second cavity 48 with a second end face 212 together with the cover 18.

The battery cells 22 are connected in series, wherein the first battery cell 221 on the first end face 211 of the battery cell packet 20 and the eighth battery cell 228 also on the first end face 211 can each be electrically connected to an external component via a cell connection element 401, 408. All battery cells 22 each have a first cell connection element 401, 402, 403, 404, 405, 406, 407, 408, on the first end face 211 of the battery cell packet 20 and a second cell connection element 421, 422, 423, 424, 425, 426, 427, 428 on the second end face 212 of the battery cell packet 20, wherein the first is electrically connected to the second battery cell, 221, 222, the third to the fourth battery cell 223, 224, the fifth to the sixth battery cell 225, 226 and the seventh to the eighth battery cell 227, 228 via the cell connection elements 42 on the second end face 212 of the battery cell packet 20 and the second is electrically connected to the third battery cell 222, 223, the fourth to the fifth battery cell 224, 225 and the sixth to the seventh battery cell 226, 227 via the cell connection elements 40 on the first end face 211 of the battery cell packet 20.

In the event of a thermal runway of a battery cell 22, a hot gas escapes from the corresponding battery cell 22 from a predefined internal pressure prevailing within the battery cell 22. For this purpose, the battery cells 22 have a degassing device 70 on one or both end faces 211, 212 of the battery cell packet 20, so that the hot gas can escape in predefined manner from one or both end faces 211, 212. In order to remove the hot gas escaping into the cavities 46, 48 from the cavities 46, 48, the base body 14 has two degassing openings 50, 52, 54, 56 associated with the cavities 46, 48.

In order to restrict infection of the intact battery cells 22 when hot gases enter the cavities 46, 48, i.e., to reduce the number of plug-in battery cells 22 that can be infected, the cavities 46, 48 are each divided into two chambers 51, 53, 55, 57. The cavity 46 is divided by the intermediate element 305 arranged between the fifth and sixth battery cells 225, 226, which projects beyond the first end face 211 of the battery cell packet 20 and adjoins the cover 16 on the end side. The cavity 48 is divided by the intermediate element 304 arranged between the fourth and fifth battery cells 224, 225, which projects beyond the second end face 212 of the battery cell packet 20 and adjoins the cover 18 on the end side.

The decisive factor is that the fifth and sixth battery cells 225, 226 are not interconnected at the first end face 211 of the battery cell packet 20, and the fourth and fifth battery cells 224, 225 are not interconnected at the second end face 212 of the battery cell packet 20, thereby allowing an extension of the intermediate elements 304, 305. To reliably divide the cavities 46, 48 in the event of damage, i.e., in the event of a thermal runway and an inflow of the hot gas into the cavities 46, 48, the intermediate elements 304, 305, as shown in FIG. 2, have a fire protection layer 311, 313 of mica on both sides, which enclose an intermediate layer 312 of the compressible foam material. The intermediate layer 312 can compensate for the volume changes of the battery cells 22 that occur during operation.

In the event of a thermal runway of a battery cell 22, the hot gas flows out of the battery cell 22 via the degassing means 70 into the corresponding chamber 51, 53, 55, 57. Starting from the corresponding chamber 51, 53, 55, 57, the hot gas flows out of the battery housing 12 through a degassing opening 50, 52, 54, 56 associated with the chambers 51, 53, 55, 57, whereby each chamber 51, 53, 55, 57 is associated with a single degassing opening 50, 52, 54, 56.

What is claimed is:

1. A battery for an electric vehicle, said battery comprising:
a battery housing which delimits a housing interior, and
a battery cell packet, which is arranged in the housing interior and has (i) at least two battery cells arranged next to each other, wherein the battery cells are electrically connected to one another via cell connection elements arranged on a first end face of the battery cell packet, and (ii) an intermediate element arranged between the two battery cells, which is configured such that the battery cells support each other via the intermediate element in a stacking direction of the battery cell packet,
wherein the intermediate element projects beyond a second end face of the battery cell packet opposite the cell connection elements such that the intermediate element divides a cavity adjacent to the second end face of the battery cell packet into a first chamber associated with the one battery cell of the two battery cells and a second chamber associated with the other battery cell of the two battery cells.

2. The battery according to claim 1, wherein the battery cell packet has at least three of the battery cells, wherein a first pair of two adjacent battery cells of the at least three battery cells are connected to each other on the first end face of the battery cell packet via the cell connection elements and a second pair of two adjacent battery cells of the at least three battery cells are electrically connected on the second end face via other cell connection elements, wherein a first intermediate element arranged between the two battery cells of the first pair projects beyond the second end face of the battery cell packet and a second intermediate element arranged between the two battery cells of the second pair projects beyond the first end face of the battery cell packet, such that a first cavity adjacent to the first end face of the battery cell packet is divided by the second intermediate element into two chambers and a second cavity adjacent to the second end face of the battery cell packet is divided by the second intermediate element into two chambers.

3. The battery according to claim 1, wherein the battery housing has a degassing opening in each chamber.

4. The battery according to claim 1, wherein the battery cells are connected in series.

5. The battery according to claim 1, wherein the intermediate element is composed of a compressible material.

6. The battery according to claim 5, wherein the intermediate element is composed of a foam material.

7. The battery according to claim 5, wherein the intermediate element is arranged in multiple layers and comprises a fire protection layer on at least one of the two sides facing the battery cells.

8. The battery according to claim 7, wherein the multi-layered intermediate element comprises two fire protection layers and an intermediate layer arranged between the two fire protection layers, wherein the intermediate layer is composed of a compressible material.

9. The battery according to claim 8, wherein each fire protection layer is composed of mica.

10. The battery according to claim 1, wherein the battery housing has (i) a base body in the form of an extruded profile and (ii) two covers closing open end faces of the base body.

11. The battery according to claim 1, wherein the battery cells each have a degassing device on at least one of the end faces of the battery cell packet, at which the intermediate element projects beyond the end face of the battery cell packet.

12. A motor vehicle comprising the battery according to claim 1.
